(19) United States
(12) Patent Application Publication
(10) Pub. No.: US 2016/0262123 A1
(43) Pub. Date: Sep. 8, 2016

(54) DOWNLINK SYNCHRONIZATION CHANNEL FOR THE NARROW-BAND CELLULAR IOT

(71) Applicant: QUALCOMM Incorporated, San Diego, CA (US)

(72) Inventors: Navid Abedini, Raritan, NJ (US); Junyi Li, Chester, NJ (US); Frank Anton Lane, Easton, PA (US)

(21) Appl. No.: 14/990,511

(22) Filed: Jan. 7, 2016

Related U.S. Application Data
(60) Provisional application No. 62/129,580, filed on Mar. 6, 2015.

(51) Int. Cl. H04W 56/00; H04J 13/00; H04W 72/04

(52) U.S. Cl. CPC H04W 56/0015; H04W 72/042; H04W 72/0446; H04J 13/0062

(57) ABSTRACT

To enable efficient synchronization and/or cell acquisition, systems and methods are described for broadcast of a synchronization signal in a synchronization channel. According to an aspect, a base station may generate a synchronization signal and assign the synchronization signal to be carried on a synchronization channel that is time-division multiplexed with one or more other channels (e.g., one or more other downlink channels). The synchronization channel may be a single-carrier channel and/or a wide-band channel. The base station may transmit synchronization signal (e.g., periodically broadcast) on the synchronization channel to enable a time and/or frequency synchronization. According to an aspect, the UE may acquire synchronization information based on detection of the repeating synchronization signal.

### CROSS-REFERENCE TO RELATED APPLICATION(S)

This application claims the benefit of U.S. Provisional Application Ser. No. 62/129,580, entitled “Downlink Synchronization Channel for the Narrow-Band Cellular IoT” and filed on Mar. 6, 2015, which is expressly incorporated by reference herein in its entirety.

### BACKGROUND

1. Field

The present disclosure relates generally to communication systems, and more particularly, to a wireless communication system that transmits a synchronization channel.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is Long Term Evolution (LTE). LTE is a set of enhancements to the Universal Mobile Telecommunications System (UMTS) mobile standard promulgated by Third Generation Partnership Project (3GPP). LTE is designed to support mobile broadband access through improved spectral efficiency, lowered costs, and improved services using OFDMA on the downlink, SC-FDMA on the uplink, and multiple-input multiple-output (MIMO) antenna technology. However, as the demand for mobile broadband access continues to increase, there exists a need for further improvements in LTE technology. These improvements may also be applicable to other multi-access technologies and the telecommunication standards that employ these technologies.

As the demand for mobile broadband access continues to increase, there exists a need for further improvements in wireless technology. For example, recently, the design of an Internet of Things (IoT) has been studied in the context of Global System for Mobile Communications (GSM) EDGE Radio Access Network (GERAN), Long Term Evolution (LTE), and the like. In connection with communication in an IoT environment, a need exists for systems and methods that facilitate efficient detection and decoding of a synchronization channel in an IoT system.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An IoT system may benefit from certain characteristics, such as the ability to support a relatively large initial carrier frequency offset (CFO) (e.g., a CFO of up to −/+eighteen (18) kilohertz (KHz) or twenty (20) parts per million at 900 megahertz (MHz)), the ability to support relatively inexpensive cellular IoT (CIoT) devices (e.g., inexpensive devices including limited battery capacity requiring efficient and less complex receiver algorithms), and the ability to support relatively large path losses corresponding to “remote” IoT devices (e.g., devices located in areas of poor coverage, such as basements and underground parking structures).

To enable efficient synchronization and/or cell acquisition, systems and methods are described infra for a synchronization channel. According to an aspect, a base station may generate a synchronization signal and may assign this synchronization signal to be carried on a synchronization channel that is time-division multiplexed with one or more other channels (e.g., one or more other downlink channels). The synchronization channel may be a single-carrier channel and/or a wide-band channel. The base station may transmit (e.g., periodically broadcast) the synchronization signal carried on the synchronization channel to enable time and/or frequency synchronization (e.g., by a CIoT UE), which may be more reliable than existing approaches and/or may reduce latency experienced in existing approaches (e.g., at a re-synchronization stage).

In an aspect of the disclosure, a method, a computer-readable medium, and an apparatus are provided. The apparatus may be configured to generate a synchronization signal for transmission in a synchronization channel. The synchronization channel spans an entire bandwidth available for downlink transmission. The synchronization signal having at least two repetitions of a sequence. The apparatus may be configured to multiplex the synchronization channel with at least one other downlink channel in at least one downlink frame. The apparatus may further be configured to transmit the at least one downlink frame having the synchronization channel multiplexed with the at least one other downlink channel.

In another aspect of the disclosure, another method, another computer-readable medium, and another apparatus are provided. The other apparatus may be configured to receive, from a base station, a downlink frame having a first channel time-divisionally multiplexed with at least one other downlink channel. The apparatus may further be configured to differentially demodulate a plurality of symbols of the first channel. The apparatus may further be configured to determine whether the first channel is a synchronization channel having at least two repetitions of a sequence based on the differential demodulation of the plurality of symbols.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a base station and user equipment in an access network.

FIG. 2 is a diagram illustrating an example of a base station of an access network transmitting a synchronization channel that may be received by a user equipment.

FIG. 3 is a diagram illustrating an example of a downlink frame structure having a synchronization channel multiplexed with one or more other downlink channels.

FIG. 4 is a flowchart of a method of wireless communication.

FIG. 5 is a flowchart of another method of wireless communication.

FIG. 6 is a conceptual data flow diagram illustrating the data flow between different means/components in an exemplary apparatus.

FIG. 7 is a conceptual data flow diagram illustrating the data flow between different means/components in another exemplary apparatus.

FIG. 8 is a diagram illustrating an example of a hardware implementation for an apparatus employing a processing system.

FIG. 9 is a diagram illustrating another example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

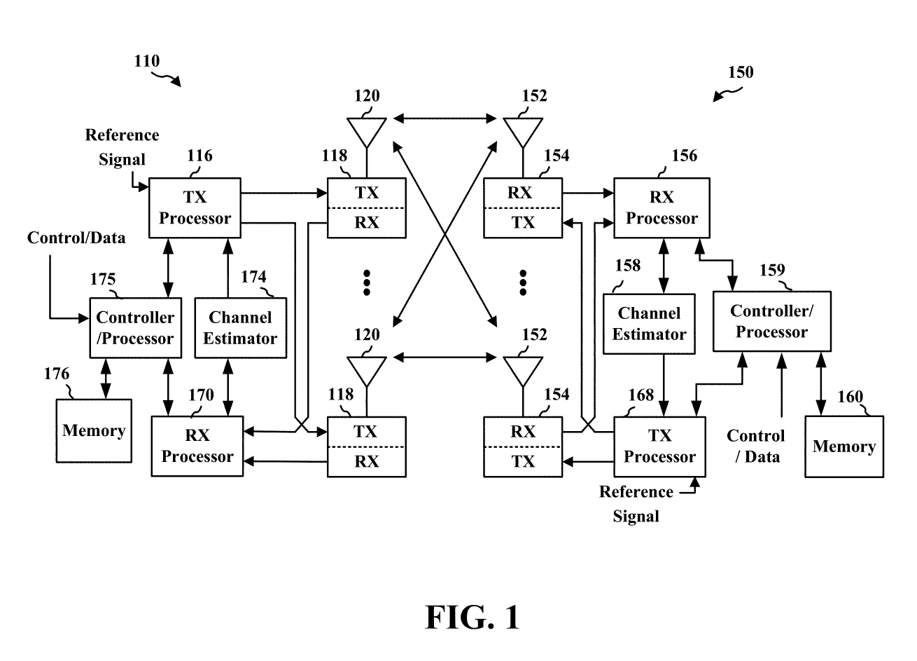

FIG. 1 is a block diagram of a base station 110 in communication with a user equipment (UE) 150 in an access network. The base station 110 may also be referred to as a Node B, evolved Node B (eNB), an access point, a base transceiver station, a radio base station, a radio transceiver, a transceiver function, a basic service set (BSS), an extended service set (ESS), or some other suitable terminology. The base station 110 provides an access point to a core network (e.g., an evolved packet core (EPC)) for a UE 150. Examples of UEs 150 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, or any other similar functioning device. The UE 150 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

In the DL, IP packets from a core network (e.g., EPC) may be provided to a controller/processor 175. The controller/processor 175 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 175 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demuliplexing of MAC SDUs from TBs, scheduling information reporting, error correction through HARQ, priority handling, and logical channel prioritization.

The transmit (TX) processor 116 and the receive (RX) processor 170 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 116 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 174 may be used to determine the coding and modulation scheme, as well as for spatial processing. The channel estimate may be derived from a reference signal and/or channel condition feedback transmitted by the UE 150. Each spatial stream may then be provided to a different antenna 120 via a separate transmitter 118TX. Each transmitter 118TX may modulate an RF carrier with a respective spatial stream for transmission.

At the UE 150, each receiver 154RX receives a signal through its respective antenna 152. Each receiver 154RX recovers information modulated onto an RF carrier and provides the information to the receive (RX) processor 156. The TX processor 168 and the RX processor 156 implement layer 1 functionality associated with various signal processing functions. The RX processor 156 may perform spatial processing on the information to recover any spatial streams destined for the UE 150. If multiple spatial streams are destined for the UE 150, they may be combined by the RX processor 156 into a single OFDM symbol stream. The RX processor 156 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 110. These soft decisions may be based on channel estimates computed by the channel estimator 158. The soft decisions are then decoded and deinterleaved to recover the data and control signals that were originally transmitted by the base station 110 on the physical channel. The data and control signals are then provided to the controller/processor 159, which implements layer 3 and layer 2 functionality.

The controller/processor 159 can be associated with a memory 160 that stores program codes and data. The memory 160 may be referred to as a computer-readable medium. In the UL, the controller/processor 159 provides demultiplexing between transport and logical channels, packet reassembly, deciphering, header decompression, and control signal processing to recover IP packets from the EPC 160. The controller/processor 159 is also responsible for error detection using an ACK and/or NACK protocol to support HARQ operations.

Similar to the functionality described in connection with the DL transmission by the base station 110, the controller/processor 159 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demuliplexing of MAC SDUs from TBs, scheduling information reporting, error correction through HARQ, priority handling, and logical channel prioritization.

Channel estimates derived by a channel estimator 158 from a reference signal or feedback transmitted by the base station 110 may be used by the TX processor 168 to select the appropriate coding and modulation schemes, and to facilitate spatial processing. The spatial streams generated by the TX processor 168 may be provided to different antenna 152 via separate transmitters 154TX. Each transmitter 154TX may modulate an RF carrier with a respective spatial stream for transmission.

The UL transmission is processed at the base station 110 in a manner similar to that described in connection with the receiver function at the UE 150. Each receiver 118RX receives a signal through its respective antenna 120. Each receiver 118RX recovers information modulated onto an RF carrier and provides the information to a RX processor 170.

The controller/processor 175 can be associated with a memory 176 that stores program codes and data. The memory 176 may be referred to as a computer-readable medium. In the UL, the controller/processor 175 provides demultiplexing between transport and logical channels, packet reassembly, deciphering, header decompression, control signal processing to recover IP packets from the UE 150. IP packets from the controller/processor 175 may be provided to the EPC 160. The controller/processor 175 is also responsible for error detection using an ACK and/or NACK protocol to support HARQ operations.

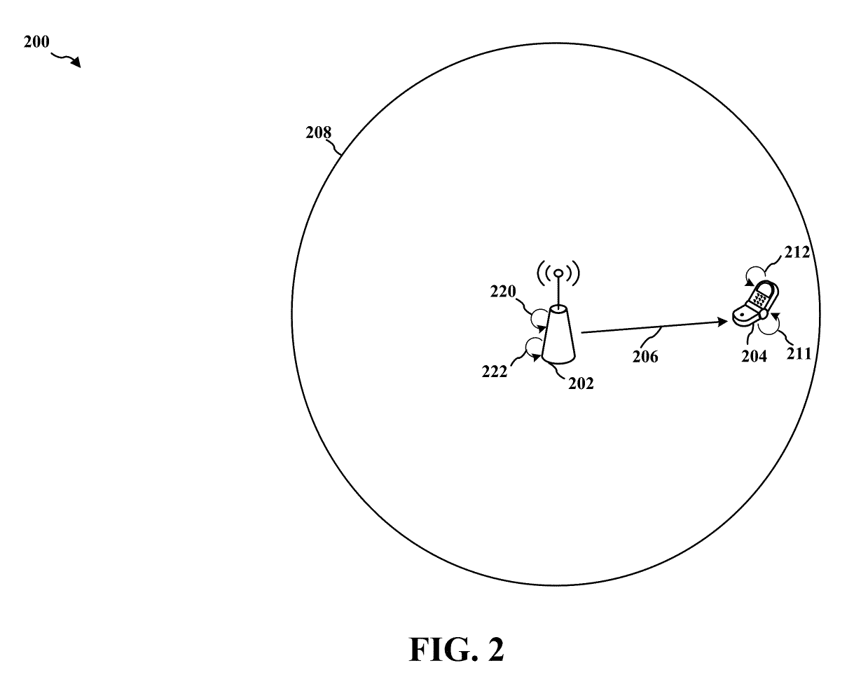

FIG. 2 is a diagram illustrating an example of a base station 202 of an access network transmitting a synchronization signal 206 that may be received by a UE 204. The base station 202 may be an aspect of a base station 110 illustrated in FIG. 1. The UE 204 may be an aspect of a UE 150 illustrated in FIG. 1. In some aspects, the base station 202 and the UE 204 may communicate as part of the CIoT, and the UE 204 may be a CIoT device. The base station 202 and the UE 204 may operate in conformance with one or more standards, such as one or more standards defined for LTE and/or GSM (e.g., GERAN) and promulgated by 3GPP.

An IoT system may benefit from certain characteristics, such as the ability to support a relatively large initial CFO (e.g., a CFO of up to −/+eighteen (18) KHz or twenty (20) parts per million at 900 MHz), the ability to support relatively inexpensive CIoT devices (e.g., inexpensive devices including limited battery capacity requiring efficient and less complex receiver algorithms), and the ability to support relatively large path losses corresponding to “remote” IoT devices (e.g., devices located in areas of poor coverage, such as basements and underground parking structures).

Cell synchronization may be an initial step for a subscriber device, such as an IoT device (e.g., the UE 204), to operate (e.g., camp) on a particular cell 208. During a process of cell synchronization, the UE 204 may receive a synchronization signal 206 transmitted from a base station 202 that provides a cell 208. From the synchronization signal 206, the UE 204 may obtain cell identification corresponding to the cell 208 (e.g., Physical Cell Identity (PCID)), as well as achieve synchronization with the cell (e.g., symbol-level and/or frame-level synchronization), thereby enabling the UE 204 to read subsequent messages transmitted by the base station 202.

In an aspect, the UE 204 may first look to detect a primary synchronization signal (PSS) carried on a synchronization channel (e.g., a physical synchronization channel (PSCH)) by sampling the synchronization signal 206 transmitted by the base station 202. The PSS may be located in one or more time slots of a radio frame of the synchronization signal 306. From the PSS, the UE 204 may be able to achieve time-level synchronization and/or frequency-level synchronization with the corresponding cell 208.

After determining a PSS, the UE 204 may be able to determine a secondary synchronization signal (SSS), which may also be carried on a synchronization channel (e.g., a PSCH)). For example, where the PSS and SSS are both carried on a PSCH, the PSS and SSS may be located in a same time slot. From the SSS, the UE 204 may be able to obtain cell identification corresponding to the cell 208. Further, the UE 204 may be able to achieve frame-level synchronization with the base station 202.

Determination of the PSS and/or SSS may be affected (e.g., delayed) by a CFO. A CFO may indicate a mismatch between different carrier frequencies used by the transmitter base station 202 and the receiver UE 204. Although the UE 204 may receive the PSS, the phase of the PSS detected by the UE 204 may be off due to the CFO (e.g., the CFO increases the phase of the PSS). In effect, a phase ramp may affect the synchronization signal 206 transmitted by the base station 202, for example, the phase of the synchronization signal 206 may increase with time. Consequently, the PSS received by the UE 204 may differ from that transmitted by the base station 202. Therefore, the UE 204 may perform one or more operations to correlate the received PSS with a reference PSS (e.g., an expected PSS stored at the UE 204 and/or determined at the UE using an index associated with PSS).

Depending on the effect (e.g., size) of the CFO, performance of the UE 204 may be undesirably degraded. For example, an amount of time for cell acquisition by the UE 204 may be undesirably large, or an amount of power needed for the UE 204 to perform cell acquisition may be unacceptably large. The present disclosure describes an approach that may reduce (e.g., “flatten”) the phase ramp introduced by a CFO. Such a reduction may allow a more desirable performance by a UE, e.g., in an IoT system.

In some systems, cell synchronization by a UE includes a sample-level search in which a UE uses a sample window to sequentially analyze samples in a sequence of samples detected in a received signal. If the UE determines that the analyzed sample is not the beginning of a PSS, the UE may advance the sample window (e.g., by a single sample) to analyze a next sample of the sequence of samples. The UE may continue such an iterative process until the UE successfully locates the beginning of a PSS. In such systems, a number of samples by which a UE may be off in its initial analysis may be relatively large if a CFO of the signal received by the UE is relatively large. As a result, the time for the UE to perform cell acquisition may be relatively large. In addition, various systems may provide a narrow-band synchronization channel (e.g., a synchronization channel that occupies a relatively small portion of an available system bandwidth), and such a synchronization channel may be multiplexed in the frequency domain with one or more other channels. Consequently, the time and/or power consumed by the UE to correctly detect a PSS may be further increased in addition to the effect of the CFO (e.g., due to path loss). Such an approach to cell synchronization may be undesirable, e.g., in IoT systems.

In aspects of the present disclosure, operations for cell synchronization are described, which may be desirable in certain systems, such as IoT systems. In an aspect, a base station 202 may generate a synchronization signal 206 so that a UE 204 may synchronize with the base station 202.

As illustrated at operation 220, the base station 202 may generate a synchronization signal 206 for transmission in a synchronization channel (e.g., a PSCH). The base station 202 may generate the synchronization signal 206 to span an entire bandwidth available for downlink transmission.

In aspects, the base station 202 may generate the synchronization signal 206 to include two repetitions of a same sequence. In aspects, a first PSS may include a first repetition of a same sequence and a second PSS may include a second repetition of the same sequence. The base station 202 may generate the sequence for the first and second PSSs based on a base sequence, which may be a pseudo-random sequence. For example, the PSS base sequence may be referred to as a sequence “S,” and “S” may be an N-length sequence (e.g., the PSS base sequence “S” may be a 205-length Kasami sequence/Kasumi sequence, KASUMI being a block cipher used in UMTS, GSM, and GPRS mobile communications systems).

Accordingly, if the PSS base sequence comprises N number of samples, the PSS base sequence may be represented by the following equation: S=s₁s₂ . . . s_{N}. In “S,” s₁ to s_{N} may each represent one of the N number of samples of the sequence. In aspects, the base station 202 may differentially modulate or differentially encode symbols of the PSS base sequence “S,” which may address a relatively large initial CFO at the receiver UE 204. For example, the base station 202 may use k-bit (or k-sample) differential modulation. With 2-bit differential modulation, the PSS may be represented by the following equation:

PSS=1 1s₁ s₂(s₁×s₃)(s₂×s₄)(s₁×s₃×s₅)(s₂×s₄×s₆) . . . (s₂×s₄ . . . ×s_{N-1})(s₁×s₃ . . . ×s_{N}).

In this example, the base station 202 may generate the synchronization signal 206 to include a plurality of initial bits (e.g., two initial bits) that precede the differentially modulated sequence, e.g., the plurality of initial bits may be (1 1). The initial bits may facilitate differential demodulation, e.g., at the receiver UE 204.

The base station 202 may generate the synchronization signal 206 to include a second repetition of the PSS base sequence. A second PSS may include the second repetition of the sequence and may be a duplicate of the first PSS.

According to an aspect, the base station 202 may generate the synchronization signal 206 to include a plurality of tail bits that follow the second repetition of the sequence (e.g., follow the second PSS in the synchronization signal 206). The base station 202 may generate the synchronization signal 206 to include the plurality of tail bits after differential modulation of the PSS base sequence. The plurality of tail bits may be identical to the plurality of initial bits. For example, the plurality of tail bits may be (1 1). In an aspect, the base station 202 may generate the synchronization signal 206 to include the two repetitions of the same sequence as shown in the following equation: X={PSS₁PSS₂tail bits}: 1 1 s₁ s₂ (s₁×s₃)(s₂×s₄)(s₁×s₃×s₅)(s₂×s₄×s₆) . . . (s₂×s₄ . . . ×s_{N-1})(s₁×s₃ . . . ×s_{N}) 1 1 s₁ s₂ (s₁×s₃)(s₂×s₄)(s₁×s₃×s₅)(s₂×s₄×s₆) . . . (s₂×s₄ . . . ×s_{N-1})(s₁×s₃ . . . ×s_{N}) 1 1.

In various aspects, the base station 202 may generate the synchronization signal 206 to include two SSSs (e.g., SSS-1 and SSS-2). The base station 202 may generate the synchronization signal 206 so that the two SSSs follow the two PSSs. In an aspect, the two SSSs may follow the plurality of tail bits that follow the second repetition of the sequence. The first SSS and the second SSS may be respective Zadoff-Chu sequences.

The first SSS and the second SSS may be different from one another and may be selected from a list of different SSS identities (ids). For example, each SSS may be selected from a list of 70 different SSS ids. In an example in which 70 different SSS ids exist, there will be 4900 (i.e., 70 multiplied by 70) different combinations of SSS-1 and SSS-2. Therefore, SSS-1 and SSS-2 are able to carry log₂(4900) (rounded down to 12) binary bits of information, which can be used by the UE 204 to determine characteristics of the cell 208 or base station 202 (e.g., a cell id, or synchronization characteristics).

In aspects, the base station 202 may assign the synchronization signal 206 to be carried on a synchronization channel (e.g., a PSCH). For example, a PSCH may carry all of the first and second PSSs (including initial bits), a plurality of tail bits following the second PSS, and first and second SSSs following the plurality of tail bits. At operation 222, the base station 202 may multiplex the synchronization channel with one or more other downlink channels in at least one downlink frame. This multiplexing operation 222 may be a time-division multiplex. The base station 202 may transmit (e.g., periodically broadcast) the synchronization signal 206, which may be time-divisionally multiplexed with the one or more other downlink channels in a downlink frame.

The UE 204 may receive the synchronization signal 206, for example, when the UE 204 is within the cell 208 provided by the base station 202. However, the UE 204 may be unaware of downlink frame structure and, therefore, may be unaware of resources carrying synchronization information (e.g., PSS, SSS, etc.). However, the UE 204 may perform one or more operations in order to achieve cell synchronization based on the downlink frame having the synchronization signal 206.

In an aspect, the UE 204 may differentially demodulate symbols of the downlink frame, including symbols of the synchronization signal 206 carried on the synchronization channel (e.g., the PSCH), as illustrated at operation 211. In an aspect, the UE 204 may perform differential demodulation according to the following equation:

\hat{X}(n)=X(n+2)*conjugate(X(n)), which may be extrapolated to the following equation:

\hat{X}=s₁ s₂ . . . s_{N-1}s_{N} (s₂×s₄ . . . ×s_{N-1})*(s₁×s₃ . . . ×s_{N})*s₁ s₂ . . . s_{N-1}s_{N} (s₂×s4 . . . ×sN−1*.

Differential modulation by the base station 202 and differential demodulation by the UE 204 (facilitated by the initial bits added by the base station 202) may allow for a sequence-level search approach for PSS detection (e.g., instead of a sample-level search approach). In a sequence-level search approach, a PSS in the synchronization signal 206 is more easily detected because the UE 204 is more easily able to recognize the repeating pattern following demodulation. For example, operations associated with processing a fixed phase offset with respect to the transmitter (e.g., the base station 202) at the receiver (e.g., the UE 204) samples, as in a sequence-level search approach for PSS detection, may be performed in the frequency domain and may be more efficient (e.g., less time consuming and/or computationally expensive than a sample-level search approach), thereby reducing latency during acquisition of cell synchronization.

At operation 212, the UE 204 may determine whether the differentially demodulated symbols of the synchronization channel carry at least two repetitions of a sequence. As described, a first PSS may include the first repetition of the sequence and a second PSS may include the second repetition of the sequence. The UE 204 may not need to detect the entirety of both repetitions of the sequence, but only to detect the sequence based on the two repetitions—e.g., the UE 204 may detect a first portion of the sequence from the first PSS and a second portion of the sequence from the second PSS, using the repeating structure and the plurality of tails bits. Based on at least of portion of the first sequence and at least a portion of the second sequence, the UE 204 may acquire a degree of synchronization with the base station 202 (e.g., coarse synchronization), such as symbol-level time synchronization as well as frequency-level synchronization (e.g., frequency offset estimation).

In an aspect, the UE 204 may sample an N-length sequence of the differentially demodulated symbols carried on the synchronization channel to detect the at least two repetitions of the sequence in the synchronization signal 206, where N is equal to an expected length of the sequence included in each PSS (including a plurality of at least one of initial bits and/or tail bits). If the UE 204 determines that the sampled differentially demodulated symbols do not include at least a portion of two repetitions of the same sequence, the UE 204 may advance a window (e.g., an N-length sample window) by N samples to sample a next N-length sequence of the differentially demodulated symbols.

In some systems, such as systems in which a receiver implements a sample-level search for PSS detection, a receiver may analyze a large number of individual samples of a demodulated signal until it finds a beginning of a PSS. However, according to the sequence-level search approach for PSS detection described herein, the UE 204 expects a repeating sequence (e.g., first and second PSSs) in the synchronization signal 206 received from the base station 202. In aspects, the UE 204 may expect a combination of a sequence, initial bits, and/or tail bits to be of a certain length (following demodulation). Accordingly, because of the repeating sequence structure, if the beginning of a sample observed by the UE 204 is anywhere after the first initial bit of the first PSS and before the first initial bit of the second PSS, the UE 204 is able to obtain a circularly shifted version of the entire sequence (e.g., because the sample window of the UE 204 includes the whole sequence, although an end portion of the sequence may be sampled from the first PSS and a beginning portion of the sequence may be sampled from the second PSS in the synchronization signal 206). Thus, the UE 204 is able to perform correlation (e.g., circular correlation, cyclic correlation, cross-correlation, autocorrelation, and the like) on the detected samples to determine the beginning of the sequence (e.g., from a beginning portion of a second PSS in a sequence-level window sampled by the UE 204). In aspects, the UE 204 may further use an index associated with PSS detection—e.g., a root index associated with the sequence repeated in the synchronization signal 206, which may be stored at the UE 204 in association with the expected sequence. Therefore, the UE 204 may acquire synchronization information, such as symbol-level time synchronization as well as frequency-level synchronization (e.g., frequency offset estimation), based on the repetitions of the sequence included in the first PSS and the second PSS of the synchronization signal 206.

For example, if the expected length of the combination of the sequence and one of the pluralities of bits (e.g., the plurality of tail bits) is N samples, the UE 204 may use an N-length sample window in analysis of the demodulated symbols. If an N-length sequence of the demodulated symbols begins within a sequence corresponding to the first PSS, the N-length sequence will end within a sequence corresponding to the second PSS. Because the first PSS and the second PSS include a same sequence, the sampled N-length sequence will include an entirety of the sequence, albeit a circularly shifted version of the sequence. If the N-length sample fails to capture the sequence (e.g., if the N-length sample begins after the first initial bit of the second PSS), then the UE 104 can advance its N-length sample window by N samples (as opposed to advancing a sample window by a single sample as in a sample-level search). That is, instead of advancing sample-by-sample in its attempt to detect the PSS, the UE 204 is able to advance sequence-by-sequence, sampling different N-length sequences containing N samples each time. Accordingly, latency of cell acquisition by the UE 204 may be reduced.

From the sequence repeated in the first and second PSSs, the UE 204 may acquire a degree of synchronization with the base station 202 (e.g., symbol-level or sample-level synchronization, frequency-level synchronization), and may thereafter detect the first and second SSSs in the synchronization signal 206. Upon detecting the first and second SSSs, the UE can obtain the cell identification (e.g., PCID) and the frame-level synchronization (e.g., based on an SSS index). In an aspect, the UE 204 may obtain cell identification and/or the frame-level synchronization based on a combination of the first SSS and the second SSS.

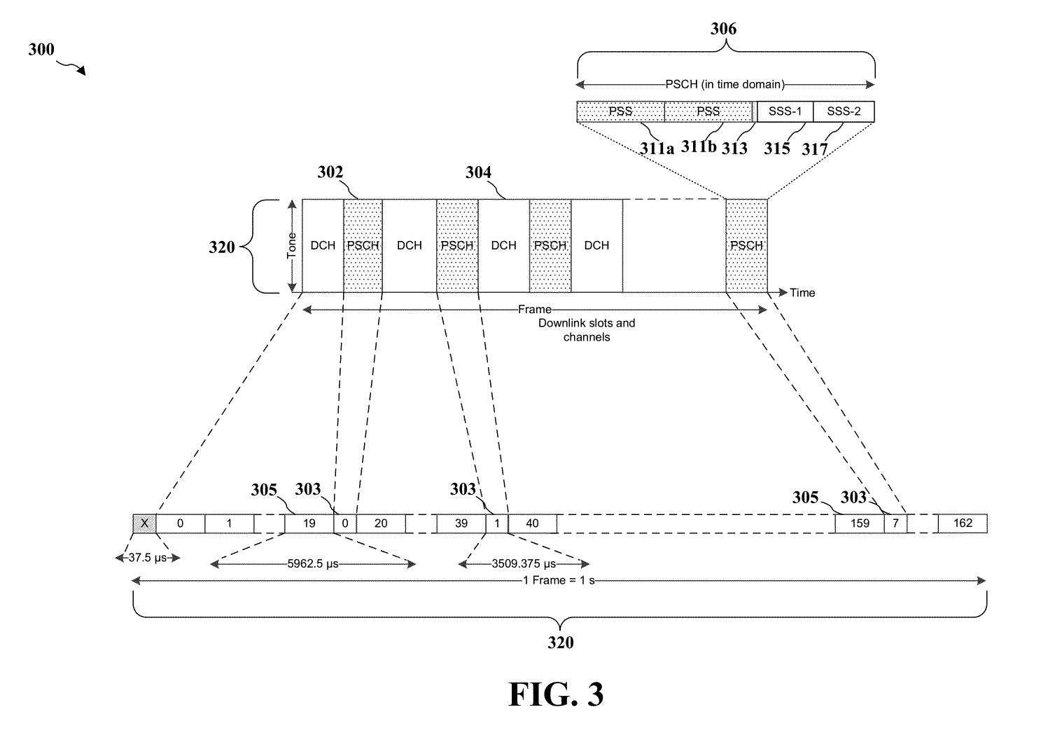

FIG. 3 is a diagram 300 illustrating an example of a downlink frame 320 structure having synchronization channel 302 that is time-divisionally multiplexed with one or more other downlink channels 304. The synchronization channel 302 may carry a synchronization signal 306. The depicted downlink frame 320 may be transmitted from a base station, such as the base station 202 shown in FIG. 2. Accordingly, the synchronization signal 306 may be an aspect of the synchronization signal 206.

In various aspects, the downlink frame 320 may be used for communication in an IoT network (such as where the UE 204 is a IoT device). Further, the downlink frame 320 may be used for communication according to GERAN. The downlink frame 320 is illustrative and, therefore, other downlink frame configurations are contemplated herein, such as downlink frame configurations adhering to LTE, LTE-A, or other similar standard.

According to various aspects, the base station 202 may generate the synchronization signal 306 based on a PSS base sequence, which may be a pseudo-random sequence, sets of initial bits and tail bits, and two SSS sequences, which may each be a Zadoff-Chu sequence.

Both the first PSS 311a and the second PSS 311b may include a base sequence. As described, the PSS base sequence may be referred to as sequence “S,” and the sequence “S” may be an N-length sequence (e.g., the PSS base sequence “S” may be a 205-length Kasami sequence/Kasumi sequence). Accordingly, if the PSS base sequence comprises N number of samples, the PSS base sequence may be represented by the following equation: S=s₁s₂ . . . s_{N}. In “S,” s₁ to s_{N} may each represent one of the N number of samples of the sequence. In the context of FIG. 2, the base station 202 may generate the synchronization signal 306.

Both the first PSS 311a and the second PSS 311b may include a set of initial bits, which may be added after differential modulation of the PSS base sequence (e.g., by a base station 202). The plurality of initial bits may precede each repetition of the sequence in both the first PSS 311a and the second PSS 311b. According to an aspect, both the first PSS 311a and the second PSS 311b may be represented by the following equation, with 2-bit differential modulation:

PSS=1 1 s₁ s₂ (s₁×s₃)(s₂×s₄)(s₁×s₃×s₅)(s₂×s₄×s₆) . . . (s₂×s₄. . . ×s_{N-1})(s₁×s₃. . . ×s_{N}).

The synchronization signal 306 may include a set of tail bits 313, which may follow the second PSS 311b in the synchronization signal 306. The set of tail bits 313 may be identical to the set of initial bits at the beginning of both the first PSS 311a and the second PSS 311b (e.g., (1 1) in the present example, although different values and/or a greater number of bits may be used as the set of initial bits and/or tail bits). The added initial bits of both the first PSS 311a and the second PSS 311b as well as the set of tail bits 313 may allow for differential demodulation and simplified detection by a UE of the sequence repeated in both the first PSS 311a and second PSS 311b.

Once the repeating sequence included in the first PSS 311a and the second PSS 311b and the set of tail bits 313 have been generated (e.g., a signal represented by {PSS₁, PSS₂, tail bits}), a first SSS 315 and a second SSS 317 (e.g., SSS-1 and SSS-2) may be included in the synchronization signal 306 following the tail bits 313. The first SSS 315 and second SSS 317 may be different from each one another and may be selected from an index of possible SSSs. For example, each SSS may be selected from a list of 70 different SSS ids. In the present example, if 70 different SSS ids exist, there will be 4900 (i.e., 70*70) different combinations of SSS-1 and SSS-2. Accordingly, SSS-1 and SSS-2 will be able to carry log₂(4900) (rounded down to twelve (12)) binary bits of information. A UE may use the first SSS 315 and the second SSS 317 to determine characteristics of a cell and/or base station (e.g., a cell-specific identity information, frame-level time synchronization, or other synchronization characteristics). A UE may use a combination of the first SSS 315 and the second SSS 317 to determine characteristics of a cell and/or base station.

The synchronization signal 306 may be carried on a synchronization channel 302, which may be a PSCH. The synchronization channel 302 may be single-carrier and may span an entire bandwidth available for downlink transmission. The synchronization channel 302 may be time-divisionally multiplexed with one or more other downlink channels 304 such that the synchronization channel 302 occurs on repeating time slots 303 in the downlink frame 320, while the one or more other downlink channels 304 may occur on other time slots 305. In the illustrated example, the synchronization signal 306 carried on the synchronization channel 302 is repeated eight (8) times per frame and occupies the entire bandwidth of the frame; however, the one or more other downlink channels 304 may be OFDMA narrow-band channels.

In an illustrative aspect, the downlink frame 320 consists of 163 normal slots 305 and eight (8) special slots 303. A leading preamble of twelve (12) samples (37.5 μs) is added in the beginning of the frame 320. The normal slots 305 have a duration of 5962.5 microseconds (μs) including fourteen (14) symbols, 140 samples for the first symbol and 136 samples for the rest. The one or more other downlink channels 304 are scheduled in the normal slots 305. The special slots 303 have a duration of 3509.375 μs. According to one aspect, each special slot 303 includes 1116 data samples, four (4) leading ramp-up samples, and three (3) tailing ramp-down samples. According to an aspect, the synchronization channel 302 is scheduled in the special slots 303, and therefore, the synchronization signal 306 may occur eight (8) times in downlink frames (including the downlink frame 320).

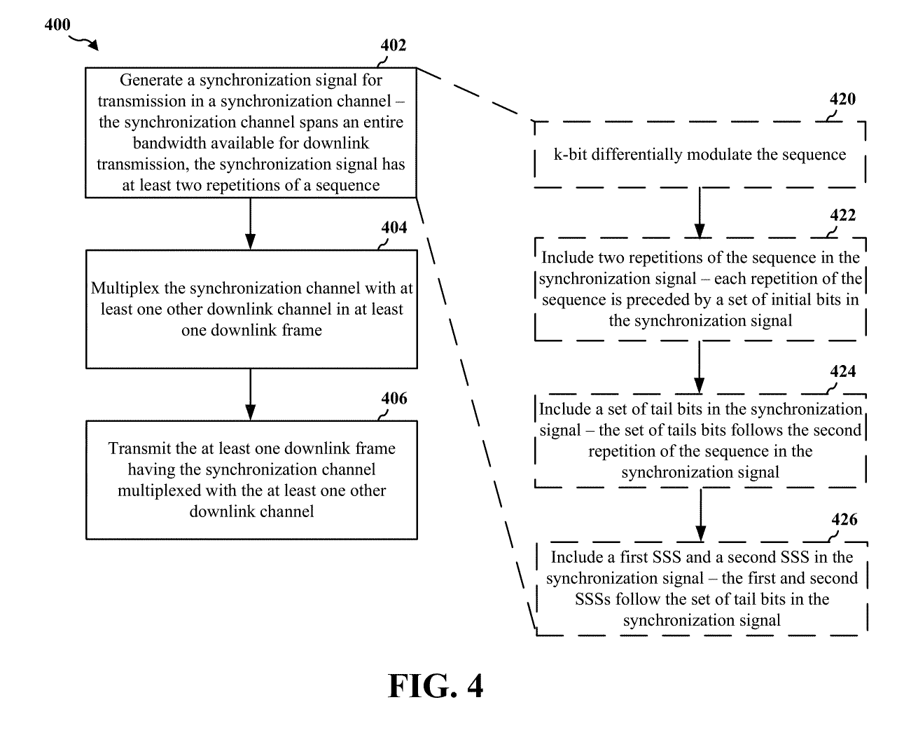

With reference to FIG. 4, a flowchart illustrates a method 400 of wireless communication. According to various aspects, the operations described with respect to FIG. 4 may facilitate detection of a synchronization signal by a UE, such as where the UE experiences a relatively large CFO and/or path loss. In one aspect, the method 400 may be performed by an apparatus, such as a base station (e.g., the base station 110 of FIG. 1, the base station 202 of FIG. 2, etc.).

In FIG. 4, various operations are illustrated as optional (e.g., denoted by dashed lines). However, the present disclosure contemplates operations in which one or more operations of the method 400 are optional, omitted, and/or alternatively performed according to various aspects. Further, one or more operations of the method 400 may be transposed and/or contemporaneously performed.

Beginning first with operation 402, an apparatus may generate a synchronization signal for transmission in a synchronization channel (e.g., a PSCH). The apparatus may generate the synchronization signal to span an entire bandwidth available for downlink transmission. The apparatus may include at least two repetitions of a sequence in the synchronization signal.

In the context of FIG. 2, the base station 202 may generate the synchronization signal 206. In the context of FIG. 3, the apparatus may generate the synchronization signal 306. The apparatus may include a first PSS 311a and a second PSS 311b in the synchronization signal 306. Each of the first PSS 311a and the second PSS 311b may include a repetition of a sequence, such as a PSS base sequence (e.g., a pseudo-random sequence). The apparatus may assign the synchronization signal 306 to the synchronization channel 302, which may span an entire bandwidth available for downlink transmission.

In various aspects, the operation 402 may include one or more of operations 420-426. At operation 420, the apparatus may k-bit differentially modulate the sequence. For example, a PSS base sequence “S” may be s₁s₂ s_{N}. In “S,” s₁ to s_{N} may each represent one of the N number of samples of the sequence. The symbols of the sequence “S” may be differentially encoded or differentially modulated. For example, with 2-bit differential modulation, including two initial bits, the sequence “S” may be included in a PSS represented as 1 1 s₁ s₂ (s₁×s3 s2×s4 s1×s3×s5 s2×s4×s6 . . . s2×s4 . . . ×sN−1 s1×s3 . . . ×sN.

In the context of FIG. 2, the base station 202 may k-bit differentially modulate the sequence “S” for inclusion in the synchronization signal 206. In the context of FIG. 3, the apparatus may differentially modulate the sequence “S” for inclusion in the first PSS 311a and the second PSS 311b.

At operation 422, the apparatus may include two repetitions of the sequence in a synchronization signal. As described with respect to respect to operation 420, each repetition of the sequence may be preceded by a set of initial bits, e.g., (1 1). In the context of FIG. 2, the base station 202 may include two repetitions of the PSS in the synchronization signal 206. In the context of FIG. 3, the apparatus may include the first PSS 311a and the second PSS 311b in the synchronization signal 306.

At operation 424, the apparatus may include a set of tail bits in the synchronization signal. In aspects, the set of tail bits may be equal to the set of initial bits, e.g., (1 1). The apparatus may include the set of tails bits following the second repetition of the sequence in the synchronization signal—e.g., the tail bits follow (in the time domain of a downlink frame) a second PSS.

In the context of FIG. 2, the base station 202 may include a set of tail bits following both repetitions of the sequence in the synchronization signal 206. In the context of FIG. 3, the apparatus may include a set of tail bits 313 in the synchronization signal 306. As illustrated, the set of tail bits 313 follows the second repetition of the sequence included in the second PSS 311b.

At operation 426, the apparatus may include a first SSS and a second SSS in the synchronization signal. Each of the first SSS and the second SSS may be a Zadoff-Chu sequence. In aspects, the first SSS and the second SSS may be different from one another. The first SSS and the second SSS may follow the set of tail bits in the synchronization signal—e.g., the first SSS follows (in the time domain of a downlink frame) the set of tails bits and the second SSS follows (in the time domain of the downlink frame) the first SSS.

In the context of FIG. 2, the base station 202 may include a first SSS and a second SSS following a set of tail bits in the synchronization signal 206. In the context of FIG. 3, the apparatus may include, in the synchronization signal 306, SSS-1 315 following the set of tail bits 313 and SSS-2 317 following SSS-1 315.

At operation 404, the apparatus may multiplex the synchronization channel with at least one other downlink channel in at least one downlink frame. In aspects, the apparatus may time-divisionally multiplex the synchronization channel with one or more other downlink channels in at least one downlink frame. While the synchronization channel may span an entire bandwidth available for downlink transmission, the one or more other downlink channels may be narrow-band channels (although not necessarily).

In the context of FIG. 2, the base station 202 may transmit the synchronization signal 206 in a synchronization channel, which may be time-divisionally multiplexed with one or more other downlink channels. In the context of FIG. 3, the apparatus may time-divisionally multiplex the synchronization channel 302 with one or more other downlink channels 304 for inclusion in the downlink frame 320.

At operation 406, the apparatus may transmit the at least one downlink frame having the synchronization channel multiplexed with the at least one other downlink channel. For example, the apparatus may broadcast the at least one downlink frame to facilitate synchronization by a IoT UE in a cell.

In the context of FIG. 2, the base station 202 may transmit (e.g., periodically broadcast) the synchronization signal 206, which may be received by the UE 204. In the context of FIG. 3, the apparatus may transmit (e.g., periodically broadcast) the at least one downlink frame 320 having the synchronization channel 302 (carrying the synchronization signal 306) multiplexed with the at least one other downlink channel 304.

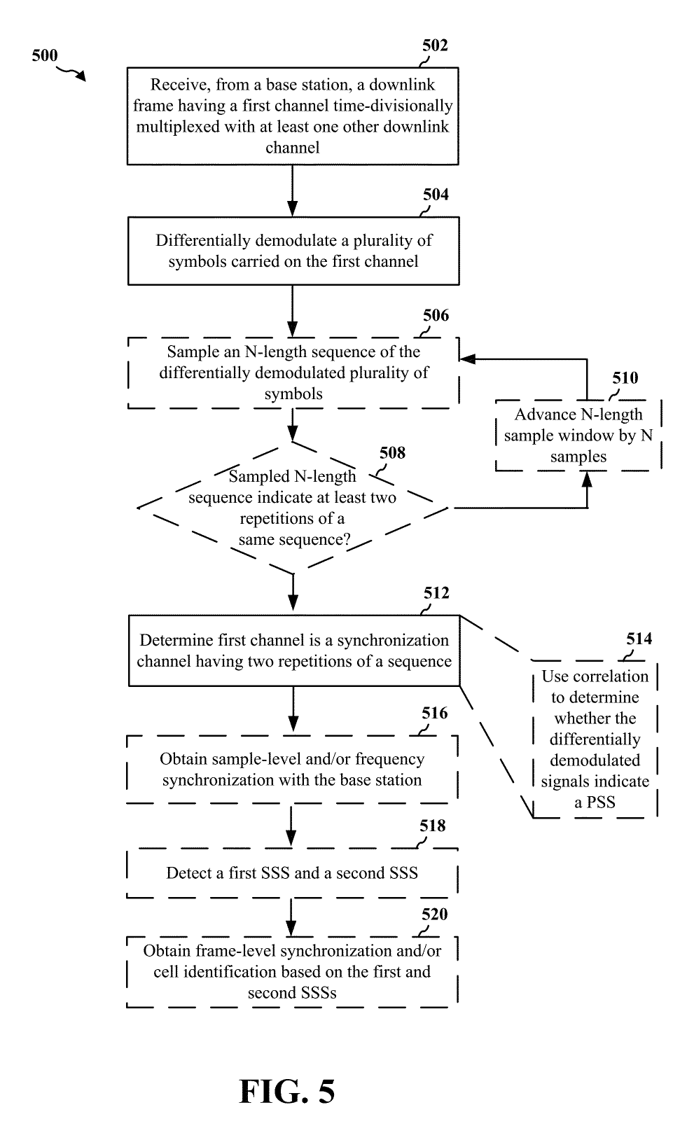

With reference to FIG. 5, a flowchart illustrates a method 500 of wireless communication. According to various aspects, the operations described with respect to FIG. 5 may facilitate detection of a synchronization signal by a UE, such as where the UE experiences a relatively large CFO and/or path loss. In one aspect, the method 500 may be performed by an apparatus, such as a UE (e.g., the UE 150 of FIG. 1, the UE 204 of FIG. 2, etc.).

In FIG. 5, various operations are illustrated as optional (e.g., denoted by dashed lines). However, the present disclosure contemplates operations in which one or more operations of the method 500 are optional, omitted, and/or alternatively performed according to various aspects. Further, one or more operations of the method 500 may be transposed and/or contemporaneously performed.

Beginning first with operation 502, an apparatus may receive, from a base station, a downlink frame having a first channel time-divisionally multiplexed with at least one other downlink channel. The first channel may span an entire bandwidth available for downlink transmission. In the context of FIG. 2, the UE 204 may receive the synchronization signal 206 from the base station 202. In the context of FIG. 3, the apparatus may receive the downlink frame 320 having the synchronization channel 302 time-divisionally multiplexed with the one or more other downlink channels 304.

At operation 504, the apparatus may differentially demodulate or differentially decode a plurality of symbols carried on the first channel. In various aspects, the apparatus may k-bit (or k-sample) differentially demodulate the plurality of symbols, such as by 2-bit differential demodulation. For example, the apparatus may perform differential demodulation according to the following equation:

\hat{X}(n)=X(n+2)*conjugate(X(n)), which may be extrapolated to the following equation:

\hat{X}=s₁ s₂ . . . s_{N-1}s_{N} (s₂×s₄ . . . ×s_{N-1})*(s₁×s₃ . . . ×s_{N})*s₁ s₂ . . . s_{N-1}s_{N} (s₂×s4 . . . ×sN−1*.

In the context of FIG. 2, the UE 204 may differentially demodulate symbols of the synchronization signal 206, which are carried on a synchronization channel. In the context of FIG. 3, the apparatus may differentially demodulate symbols of the downlink frame 320, including symbols corresponding to the synchronization signal 306 carried on the synchronization channel 302.

At operation 506, the apparatus may sample an N-length sequence of the differentially demodulated plurality of symbols (e.g., based on an N-length sample window), where N is equal to an expected length of a sequence included in a PSS (including a plurality of at least one of initial bits and/or tail bits). In the context of FIG. 2, the UE 204 may sample an N-length sequence of differentially demodulated symbols of a downlink frame, which may include symbols corresponding to the synchronization signal 206 that are carried on a synchronization channel. In the context of FIG. 3, the apparatus may sample an N-length sequence of differentially demodulated symbols of the downlink frame 320, including symbols carried on the synchronization channel 302 corresponding to the synchronization signal 306.

At operation 508, the apparatus may determine if the sampled N-length sequence indicates at least two repetitions of a same sequence. In the context of FIG. 2, the UE 204 may determine if the synchronization signal 206 includes at least two repetitions of the same sequence. In the context of FIG. 3, the apparatus may determine if the synchronization channel 302 carries at least two repetitions of a sequence, a first repetition of the sequence being included in the first PSS 311a and a second repetition of the sequence being included in the second PSS 311b.

If the apparatus determines that the sampled N-length sequence does not indicate two repetitions of the same sequence, the apparatus may proceed to operation 510. At operation 510, the apparatus may advance an N-length window by N samples to sample a next N-length sequence of differentially demodulated symbols. In the context of FIG. 2, the UE 204 may advance an N-length window to sample an N-length sequence of differentially demodulated symbols of a downlink frame, which may include symbols corresponding to the synchronization signal 206 that are carried on a synchronization channel. In the context of FIG. 3, the apparatus may sample an N-length sequence of differentially demodulated symbols of the downlink frame 320, including symbols corresponding to the synchronization signal 306 carried on the synchronization channel 302.

If the apparatus determines that the sampled N-length sequence does indicate two repetitions of the same sequence, the apparatus may proceed to operation 512. At operation 512, the apparatus may determine that the first channel is a synchronization channel having two repetitions of a sequence. In the context of FIG. 2, the UE 204 may determine that synchronization signal 206 indicates information to be used for synchronization based on the two repetitions of the sequence in the synchronization signal 206. In the context of FIG. 3, the apparatus may determine that the downlink frame 320 includes information to be used for synchronization based on the repetitions of the sequence included in the first PSS 311a and the second PSS 311b, which are carried on the synchronization channel 302 (and may appear in special slots 303 of the downlink frame 320).

According to one aspect, operation 512 may include operation 514. At operation 514, the apparatus may use correlation (e.g., circular correlation, cyclic correlation, cross-correlation, autocorrelation, and the like) on the detected N-length sequence to determine the beginning of the sequence. In aspects, the apparatus may further use an index associated with PSS detection—e.g., a root index associated with the sequence repeated in the synchronization signal, which may be stored at the apparatus in association with the expected sequence.

In the context of FIG. 2, the UE 204 may perform correlation on the N-length sequence sampled from synchronization signal 206 to determine the beginning of the sequence (e.g., from a beginning portion of a second PSS in a sequence-level window sampled by the UE 204). In the context of FIG. 3, the apparatus may perform correlation on the N-length sequence sampled from the synchronization signal 306 to determine the beginning of the sequence repeated in the first PSS 311a and the second PSS 311b (e.g., from a beginning portion of the second PSS 311b in a sequence-level window sampled by the apparatus).

At operation 516, the apparatus may obtain sample-level or symbol-level synchronization and/or frequency synchronization (e.g., frequency offset estimation) based on at least one of the repetitions of the sequence included in the synchronization signal. In one aspect, this sample-level or symbol-level synchronization and/or frequency synchronization may be considered coarse synchronization. In the context of FIG. 2, the UE 204 may acquire synchronization information, such as symbol-level synchronization as well as frequency-level synchronization (e.g., frequency offset estimation) for the base station 202, based on the repetitions of the sequence included in the synchronization signal 206. In the context of FIG. 3, the apparatus may acquire synchronization information, such as symbol-level synchronization as well as frequency-level synchronization (e.g., frequency offset estimation) for the base station, based on the repetitions of the sequence included in the first PSS 311a and the second PSS 311b of the synchronization signal 306.

Based on operation 516 (e.g., based on coarse synchronization, such as symbol-/sample-level and/or frequency synchronization), the apparatus may perform operation 518. At operation 518, the apparatus may detect a first SSS and a second SSS. In the context of FIG. 2, the UE 204 may detect a first SSS and a second SSS in the synchronization signal 206. In the context of FIG. 3, the apparatus may detect SSS-1 315 and SSS-2 317 in the synchronization signal 306.

At operation 520, the apparatus may obtain frame-level synchronization and/or cell identification (e.g., PCID) for the base station based on the first and second SSSs, which may be referred to as fine synchronization. In an aspect, the apparatus may use a combination of the first SSS and the second SSS to achieve fine synchronization. Hereafter, the apparatus may be synchronized with the base station and able to detect signals carried on channels from the base station.

In the context of FIG. 2, the UE 204 may obtain frame-level synchronization as well as cell identification for the base station 202 based on the first and second SSSs included in the synchronization signal 206. In the context of FIG. 3, the apparatus may obtain frame-level synchronization as well as cell identification for the base station based on SSS-1 315 and SSS-2 of the synchronization signal 306.

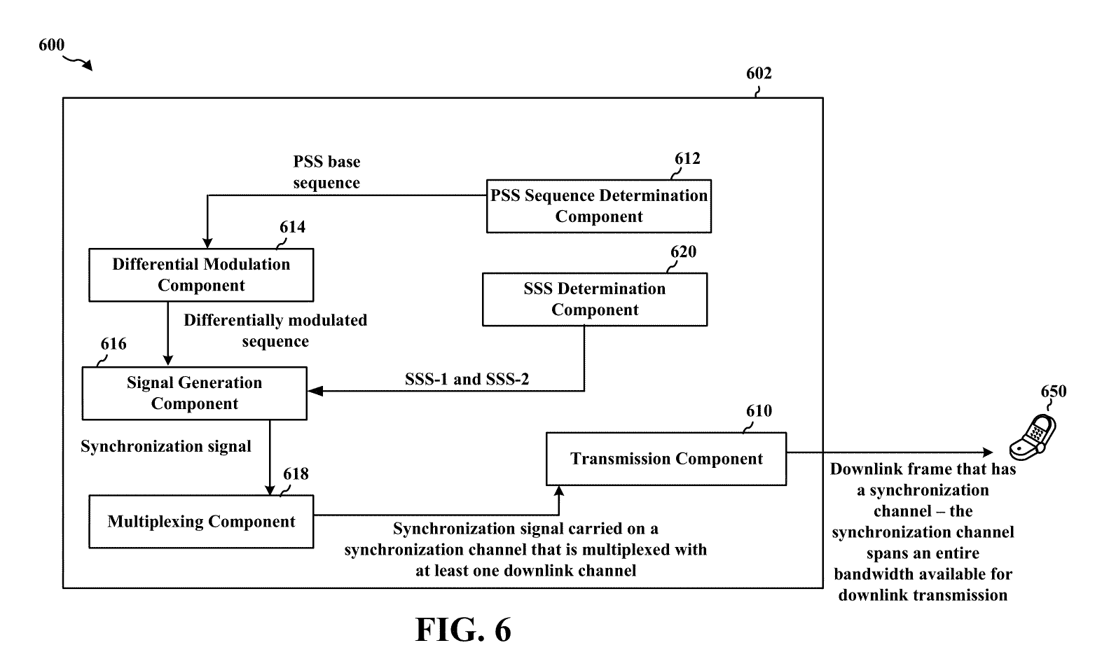

FIG. 6 is a conceptual data flow diagram 600 illustrating the data flow between different means/components in an exemplary apparatus 602. The apparatus may be a base station (e.g., the base station 110 of FIG. 1 and/or the base station 202 of FIG. 2). The apparatus 602 depicts exemplary connections and/or data between different modules/means/components. It is to be understood that such connections and/or data flow are to be regarded in as illustrative and, therefore, different and/or additional connections and/or data flow may be present in different aspects.

The apparatus 602 may include a sequence determination component 612. The sequence determination component 612 may be configured to determine a sequence that is to be broadcast in association with synchronization with the apparatus 602. In an aspect, the sequence determination component 612 may determine (e.g., select, generate, derive, etc.) a sequence that is to be included in a PSS. For example, the sequence determination component 612 may determine a PSS base sequence “S.” The PSS base sequence “S” may be represented as s₁s₂ . . . s_{N}. In “S,” s₁ to s_{N} may each represent one of the N number of samples of the sequence.

The sequence determination component 612 may provide the sequence to a differential modulation component 614. The differential modulation component 614 may be configured to differentially modulate (or differentially encode) the sequence determined by the sequence determination component 612. For example, the differential modulation component 614 may be configured to k-bit (or k-sample) differentially modulate the sequence. For example, symbols of the sequence “S” may be differentially encoded or differentially modulated. Further, with 2-bit differential modulation, including two initial bits (e.g., for differential demodulation), the sequence “S” may be represented after differential modulation as 1 1 s₁ s₂ (s₁×s₃)(s₂×s₄)(s₁×s₃×s₅)(s₂×s₄×s₆) . . . (s₂×s4 . . . ×sN−1 s1×s3 . . . ×sN. This differentially modulated sequence (including initial bits) may be a PSS to be used in association with synchronization with the apparatus 602. The differential modulation component 614 may provide the differentially modulated sequence to a signal generation component 616.

Additionally, the apparatus 602 may include an SSS determination component 620. The SSS determination component 620 may be configured to determine (e.g., select, generate, derive, etc.) two SSSs—e.g., SSS-1 and SSS-2. SSS-1 and SSS-2 may be different from one another. In an aspect, both SSS-1 and SSS-2 may be Zadoff-Chu sequences. In an aspect, both SSS-1 and SSS-2 may be selected from a list of different SSS ids. For example, each SSS may be selected from a list of 70 different SSS ids. In an example in which 70 different SSS ids exist, there will be 4900 (i.e., 70 multiplied by 70) different combinations of SSS-1 and SSS-2. Therefore, SSS-1 and SSS-2 are able to carry log₂(4900) (rounded down to 12) binary bits of information, which can be used by a UE to determine characteristics of the apparatus 602 (e.g., a cell id, such as a PCID, or synchronization characteristics, such as frame-level synchronization). The SSS determination component 620 may provide SSS-1 and SSS-2 to the signal generation component 616.

The signal generation component 616 may generate a synchronization signal that includes two repetitions of the differentially modulated sequence from the differential modulation component 614. Further, the signal generation component 616 may include a set of tail bits following the second repetition of the differentially modulated sequence in the synchronization signal. For example, the signal generation component 616 may include “X” in the synchronization signal, which may be represented as X={PSS₁PSS₂tail bits}: 1 1 s₁ s₂ (s₁×s₃)(s₂×s₄)(s₁×s₃×s₅)(s₂×s₄×s₆) . . . (s₂×s₄ . . . ×s_{N-1}) (s₁×s₃×s_{N}) 1 1 s₁ s₂ (s₁×s₃)(s₂×s₄)(s₁×s₃×s₅)(s₂×s₄×s₆) . . . (s₂×s₄ . . . ×s_{N-1})(s₁×s₃ . . . ×s_{N}) 1 1.

Further, the signal generation component 616 may include both SSS-1 and SSS-2 in the synchronization signal. In aspects, the signal generation component 616 may include SSS-1 after the tail bits and include SSS-2 after SSS-1. For example, the signal generation component 616 may generate a synchronization signal that may be represented as {PSS₁,PSS₂,tailbits,SSS-1,SSS-2}. The signal generation component 616 may provide the synchronization signal to a multiplexing component 618.

The multiplexing component 618 may assign the synchronization signal to resources of a synchronization channel. For example, the multiplexing component 618 may assign the synchronization signal to be carried on a PSCH. The multiplexing component 618 may time-divisionally multiplex the synchronization channel with one or more other downlink channels. The multiplexing component 618 may provide, to a transmission component 610, the synchronization signal that is carried on the synchronization channel multiplexed with one or more other downlink channels.

The transmission component 610 may be configured to transmit (e.g., periodically broadcast) signals. For example, the transmission component 610 may broadcast a downlink frame having the synchronization channel. In the transmission, the synchronization channel may span an entire bandwidth available for downlink transmission. A UE may receive the broadcast having the synchronization signal carried on the synchronization channel in the downlink frame.

The apparatus may include additional components that perform each of the blocks of the algorithm in the aforementioned flowchart of FIG. 4. As such, each block in the aforementioned flowchart of FIG. 4 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

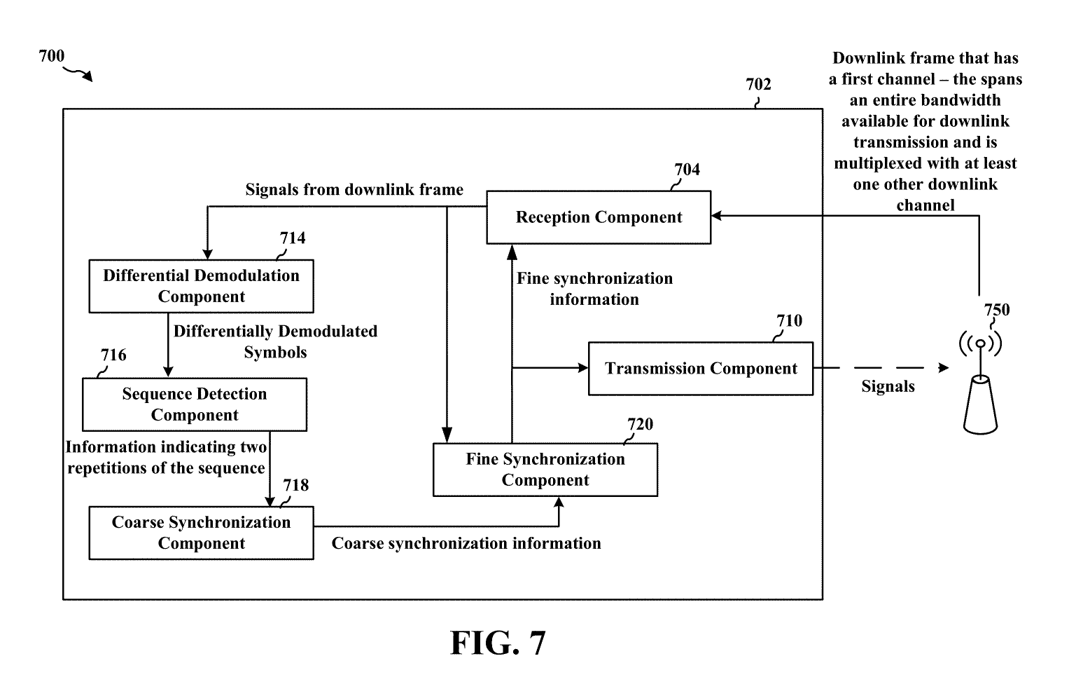

FIG. 7 is a conceptual data flow diagram 700 illustrating the data flow between different means/components in an exemplary apparatus 702. The apparatus 702 may be a UE configured for CIoT communication (e.g., the UE 150 of FIG. 1 and/or the UE 204 of FIG. 2). The apparatus 702 depicts exemplary connections and/or data between different modules/means/components. It is to be understood that such connections and/or data flow are to be regarded in as illustrative and, therefore, different and/or additional connections and/or data flow may be present in different aspects.

In various aspects, the apparatus 702 may need to acquire synchronization with a base station (e.g., a base station 750). In an aspect, the apparatus 702 may be configured to enter a “sleep” mode, such as when the apparatus 702 is a CIoT device. In such an aspect, the apparatus 702 may require synchronization with the base station each time the apparatus 702 “wakes up” from the “sleep” mode (e.g., resynchronize). The apparatus 702 may include various components to first acquire coarse synchronization (e.g., sample- or symbol-level synchronization, frequency synchronization (e.g., frequency offset estimation), etc.) and then acquire fine synchronization (e.g., frame-level synchronization, cell identity (e.g., PCID), etc.) based on the coarse synchronization.

In various aspects, the apparatus 702 may include a reception component 704. The reception component 704 may receive signals carried on channels in downlink frames from a base station, such as the base station 750. In an aspect, the reception component 704 may receive a downlink frame having a first channel that spans an entire bandwidth available for downlink transmission. Further, the first channel may be time-divisionally multiplexed with at least one other downlink channel (which may be a narrow-band channel). The first channel may be a synchronization channel, although the apparatus 702 may be unaware of downlink frame structure (e.g., when the apparatus 702 “wakes up”) and, consequently, may be unaware that the first channel is a synchronization channel. The reception component 704 may provide signals carried on the first channel to a differential demodulation component 714.

The differential demodulation component 714 may be configured to differentially demodulate symbols of the signal provided by the reception component 704. For example, the differential demodulation component 714 may k-bit (or k-sample) differentially demodulate a plurality of symbols from the signal, such as by 2-bit differential demodulation. For example, the differential demodulation component 714 may perform differential demodulation according to the following equation:

\hat{X}(n)=X(n+2)*conjugate(X(n)), which may be extrapolated to the following equation:

\hat{X}=s₁ s₂ . . . s_{N-1}s_{N} (s₂×s₄ . . . ×s_{N-1})*(s₁×s₃ . . . ×s_{N})*s₁ s₂ . . . s_{N-1}s_{N} (s₂×s4 . . . ×sN−1*.

The differential demodulation component 714 may provide a plurality of differentially demodulated symbols to a sequence detection component 716. The sequence detection component 716 may be configured to determine whether the first channel is a synchronization channel carrying two repetitions of a same sequence based on the differentially demodulated symbols provided by the differential demodulation component 714.

According to one aspect, the sequence detection component 716 may sample an N-length sequence of the differentially demodulated plurality of symbols (e.g., based on an N-length sample window), where N is equal to an expected length of a sequence included in a PSS (including a plurality of at least one of initial bits and/or tail bits). The sequence detection component 716 may determine if the sampled N-length sequence indicates at least two repetitions of a same sequence. If the sequence detection component 716 determines that the sampled N-length sequence does not indicate two repetitions of the same sequence, the sequence detection component 716 may advance an N-length window by N samples to sample a next N-length sequence of differentially demodulated symbols.

If the sequence detection component 716 determines that the sampled N-length sequence does indicate two repetitions of the same sequence, the sequence detection component 716 may determine that the first channel is a synchronization channel carrying information indicating coarse synchronization with the base station 750.

According to one aspect, the sequence detection component 716 may detect the two repetitions of the sequence based on correlation (e.g., circular correlation, cyclic correlation, cross-correlation, autocorrelation, and the like) on the detected N-length sequence. In aspects, the sequence detection component 716 may further use an index associated with PSS detection—e.g., a root index associated with the sequence repeated in the synchronization signal, which may be stored at the apparatus 702 in association with the expected sequence.

The sequence detection component 716 may provide information indicating two repetitions of the same sequence to a coarse synchronization component 718. In various aspects, the information indicating two repetitions of the same sequence may include the detected sequence, information associated with the correlation, information associated with a phase shift between symbols of the sequence and an expected sequence, and/or any other similar information.

From the information provided by the sequence detection component 716, the coarse synchronization component 718 may obtain coarse synchronization with the base station 750. Coarse synchronization may include sample- or symbol-level synchronization and/or frequency synchronization (e.g., frequency offset estimation). The coarse synchronization component 718 may provide this coarse synchronization information to a fine synchronization component 720.

Based coarse synchronization information, the fine synchronization component 720 may detect a first SSS and a second SSS. The fine synchronization component 720 may detect the first SSS and the second SSS in signals from a downlink frame provided by the reception component 704. Based on the first SSS and the second SSS (e.g., a combination of the first SSS and the second SSS), the fine synchronization component 720 may obtain fine synchronization with the base station 750. Fine synchronization may include frame-level synchronization and/or cell identification (e.g., PCID) of the base station. The fine synchronization component 720 may provide information indicating this fine synchronization to a reception component 704 and/or a transmission component 710. Hereafter, the reception component 704 and/or the transmission component 710 may be synchronized with the base station 750 and able to detect signals carried on channels from the base station and/or send signals carried on channels expected by the base station 750.

The apparatus may include additional components that perform each of the blocks of the algorithm in the aforementioned flowchart of FIG. 5. As such, each block in the aforementioned flowchart of FIG. 5 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

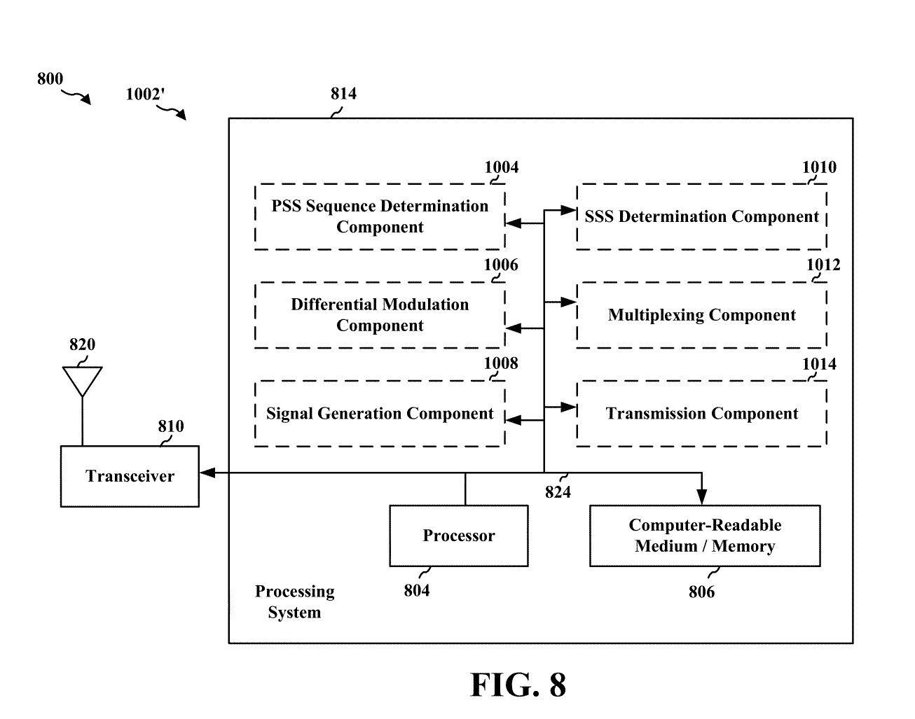

FIG. 8 is a diagram 800 illustrating an example of a hardware implementation for an apparatus 1002′ employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware components, represented by the processor 804, the components 1004, 1006, 1008, 1010, 1012, 1014 and the computer-readable medium/memory 806. The bus 824 may also link various other circuits such as timing sources, peripherals, voltage regulators, and power management circuits, which are well known in the art, and therefore, will not be described any further.

The processing system 814 may be coupled to a transceiver 810. The transceiver 810 is coupled to one or more antennas 820. The transceiver 810 provides a means for communicating with various other apparatus over a transmission medium. The transceiver 810 receives a signal from the one or more antennas 820, extracts information from the received signal, and provides the extracted information to the processing system 814. In addition, the transceiver 810 receives information from the processing system 814, specifically the transmission component 1014, and based on the received information, generates a signal to be applied to the one or more antennas 820. The processing system 814 includes a processor 804 coupled to a computer-readable medium/memory 806. The processor 804 is responsible for general processing, including the execution of software stored on the computer-readable medium/memory 806. The software, when executed by the processor 804, causes the processing system 814 to perform the various functions described supra for any particular apparatus. The computer-readable medium/memory 806 may also be used for storing data that is manipulated by the processor 804 when executing software. The processing system 814 further includes at least one of the components 1004, 1006, 1008, 1010, 1012, 1014. The components may be software components running in the processor 804, resident/stored in the computer readable medium/memory 806, one or more hardware components coupled to the processor 804, or some combination thereof. The processing system 814 may be a component of the base station 110 and may include the memory 176 and/or at least one of the TX processor 116, the RX processor 170, and the controller/processor 175.

In one configuration, the apparatus 602/1102′ for wireless communication includes means for generating a synchronization signal for transmission in a synchronization channel. The synchronization channel spans an entire bandwidth available for downlink transmission. The synchronization signal has at least two repetitions of a sequence. The apparatus 602/1102′ further includes means for multiplexing the synchronization channel with at least one other downlink channel in at least one downlink frame. The apparatus 602/1102′ further includes means for transmitting the at least one downlink frame having the synchronization channel multiplexed with the at least one other downlink channel.

In an aspect, the means for multiplexing is configured to time-divisionally multiplex the synchronization channel with the at least one other downlink channel. In an aspect, the synchronization signal comprises a first primary synchronization signal that includes a first repetition of the sequence and a second primary synchronization signal that includes a second repetition of the sequence, the synchronization signal including plurality of initial bits preceding the first repetition of the sequence. In an aspect, the synchronization signal further comprises a plurality of tail bits following the second repetition of the sequence. In an aspect, the plurality of tail bits is the same as the plurality of initial bits.

The apparatus 602/1102′ may further include means for differentially modulating a base sequence to generate the sequence. In an aspect, the synchronization signal further comprises a first secondary synchronization signal and a second secondary synchronization signal, the first secondary synchronization signal and the second secondary synchronization signal to follow both the first primary synchronization signal and the second primary synchronization signal in the synchronization signal. In an aspect, each of the secondary synchronization signals comprises a respective Zadoff-Chu sequence.

The aforementioned means may be one or more of the aforementioned components of the apparatus 602 and/or the processing system 814 of the apparatus 1002′ configured to perform the functions recited by the aforementioned means. As described supra, the processing system 814 may include the TX Processor 116, the RX Processor 170, and the controller/processor 175. As such, in one configuration, the aforementioned means may be the TX Processor 116, the RX Processor 170, and the controller/processor 175 configured to perform the functions recited by the aforementioned means.

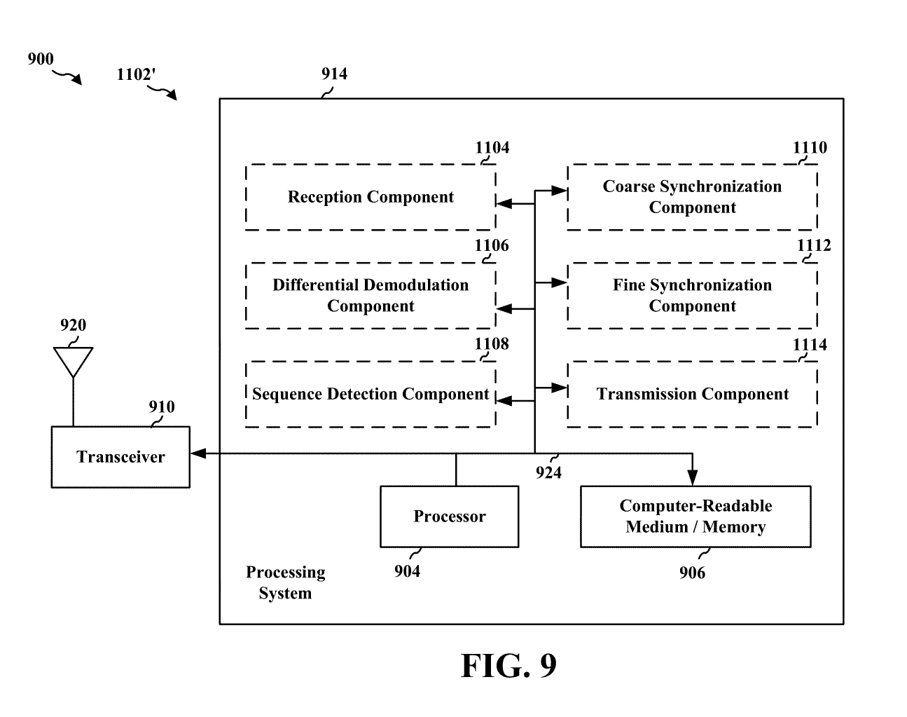

FIG. 9 is a diagram 900 illustrating an example of a hardware implementation for an apparatus 1102′ employing a processing system 914. The processing system 914 may be implemented with a bus architecture, represented generally by the bus 924. The bus 924 may include any number of interconnecting buses and bridges depending on the specific application of the processing system 914 and the overall design constraints. The bus 924 links together various circuits including one or more processors and/or hardware components, represented by the processor 904, the components 1104, 1106, 1108, and the computer-readable medium/memory 906. The bus 924 may also link various other circuits such as timing sources, peripherals, voltage regulators, and power management circuits, which are well known in the art, and therefore, will not be described any further.

The processing system 914 may be coupled to a transceiver 910. The transceiver 910 is coupled to one or more antennas 920. The transceiver 910 provides a means for communicating with various other apparatus over a transmission medium. The transceiver 910 receives a signal from the one or more antennas 920, extracts information from the received signal, and provides the extracted information to the processing system 914, specifically the reception component 1104. In addition, the transceiver 910 receives information from the processing system 914, specifically the transmission component 1114, and based on the received information, generates a signal to be applied to the one or more antennas 920. The processing system 914 includes a processor 904 coupled to a computer-readable medium/memory 906. The processor 904 is responsible for general processing, including the execution of software stored on the computer-readable medium/memory 906. The software, when executed by the processor 904, causes the processing system 914 to perform the various functions described supra for any particular apparatus. The computer-readable medium/memory 906 may also be used for storing data that is manipulated by the processor 904 when executing software. The processing system 914 further includes at least one of the components 1104, 1106, 1108, 1110, 1112, 1114. The components may be software components running in the processor 904, resident/stored in the computer readable medium/memory 906, one or more hardware components coupled to the processor 904, or some combination thereof. The processing system 914 may be a component of the UE 150 and may include the memory 160 and/or at least one of the TX processor 168, the RX processor 156, and the controller/processor 159.

In one configuration, the apparatus 702/1102′ for wireless communication includes means for receiving, from a base station, a downlink frame having a first channel time-divisionally multiplexed with at least one other downlink channel. The apparatus 702/1102′ further includes means for differentially demodulating a plurality of symbols of the first channel. The apparatus 702/1102′ further includes means for determining whether the first channel is a synchronization channel having at least two repetitions of a sequence based on the differential demodulation of the plurality of symbols. In an aspect, the synchronization channel carries a first primary synchronization signal that includes a first repetition of the sequence and a second primary synchronization signal that includes a second repetition of the sequence.

The apparatus 702/1102′ may further include means for detecting a first secondary synchronization signal and a second secondary synchronization signal based on at least one repetition of the sequence. The apparatus 702/1102′ may further include means for determining at least one of frame-level synchronization and a cell identification corresponding to the base station based on both the first and second secondary synchronization signals. The apparatus 702/1102′ may further include means for sampling an N-length sequence of the differentially demodulating symbols of the first channel, wherein N is equal to an expected length of the sequence and a plurality of tail bits. The apparatus 702/1102′ may further include means for performing at least one of sample-level synchronization and frequency synchronization with the base station based on at least one repetition of the sequence. In an aspect, the means for determination of whether the first channel is a synchronization channel having at least two repetitions of a sequence based on the differential demodulation of the symbols is configured to use correlation to determine whether the differentially demodulated symbols indicate a PSS.

The aforementioned means may be one or more of the aforementioned components of the apparatus 1102 and/or the processing system 914 of the apparatus 1102′ configured to perform the functions recited by the aforementioned means. As described supra, the processing system 914 may include the TX Processor 168, the RX Processor 156, and the controller/processor 159. As such, in one configuration, the aforementioned means may be the TX Processor 168, the RX Processor 156, and the controller/processor 159 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a base station, the method comprising:
generating a synchronization signal for transmission in a synchronization channel, the synchronization channel spanning an entire bandwidth available for downlink transmission, the synchronization signal having at least two repetitions of a sequence;
multiplexing the synchronization channel with at least one other downlink channel in at least one downlink frame; and
transmitting the at least one downlink frame having the synchronization channel multiplexed with the at least one other downlink channel.

2. The method of claim 1, wherein the synchronization channel is time-division multiplexed with the at least one other downlink channel.

3. The method of claim 1, wherein the synchronization signal comprises a first primary synchronization signal that includes a first repetition of the sequence and a second primary synchronization signal that includes a second repetition of the sequence, the synchronization signal including plurality of initial bits preceding the first repetition of the sequence.

4. The method of claim 3, wherein the synchronization signal further comprises a plurality of tail bits following the second repetition of the sequence.

5. The method of claim 4, wherein the plurality of tail bits is the same as the plurality of initial bits.

6. The method of claim 3, further comprising:
differentially modulating a base sequence to generate the sequence.

7. The method of claim 3, wherein the synchronization signal further comprises a first secondary synchronization signal and a second secondary synchronization signal, the first secondary synchronization signal and the second secondary synchronization signal to follow both the first primary synchronization signal and the second primary synchronization signal in the synchronization signal.

8. The method of claim 7, wherein each of the secondary synchronization signals comprises a respective Zadoff-Chu sequence.

9. The method of claim 7, wherein a combination of the first and second secondary synchronization signals indicates information for at least one of cell identification or frame-level synchronization.

10. A method of wireless communication of a user equipment (UE), the method comprising:
receiving, from a base station, a downlink frame having a first channel time-divisionally multiplexed with at least one other downlink channel;
differentially demodulating a plurality of symbols of the first channel; and
determining whether the first channel is a synchronization channel having at least two repetitions of a sequence based on the differential demodulation of the plurality of symbols.

11. The method of claim 10, wherein the synchronization channel spans an entire bandwidth available for downlink transmission to the UE from the base station.

12. The method of claim 10, wherein the synchronization channel carries a first primary synchronization signal that includes a first repetition of the sequence and a second primary synchronization signal that includes a second repetition of the sequence.

13. The method of claim 12, further comprising:
detecting a first secondary synchronization signal and a second secondary synchronization signal based on at least one repetition of the sequence; and
determining at least one of a frame-level synchronization and a cell identification corresponding to the base station based on both the first and second secondary synchronization signals.

14. The method of claim 10, further comprising: sampling an N-length sequence of the differentially demodulating symbols of the first channel, wherein N is equal to an expected length of the sequence and a plurality of tail bits.

15. The method of claim 10, further comprising:
performing at least one of sample-level synchronization and frequency synchronization with the base station based on at least one repetition of the sequence.

16. The method of claim 10, wherein the determining whether the first channel is a synchronization channel having at least two repetitions of a sequence based on the differential demodulation of the symbols comprises:
using correlation to determine whether the differentially demodulated symbols indicate a primary synchronization signal (PSS).

17. An apparatus for wireless communication, the apparatus comprising:
a memory; and
at least one processor coupled to the memory and configured to:
generate a synchronization signal for transmission in a synchronization channel, the synchronization channel spanning an entire bandwidth available for downlink transmission, the synchronization signal having at least two repetitions of a sequence;
multiplex the synchronization channel with at least one other downlink channel in at least one downlink frame; and
transmit the at least one downlink frame having the synchronization channel multiplexed with the at least one other downlink channel.

18. The apparatus of claim 17, wherein the at least one processor is configured to time-divisionally multiplex the synchronization channel with the at least one other downlink channel.

19. The apparatus of claim 17, wherein the synchronization signal comprises a first primary synchronization signal that includes a first repetition of the sequence and a second primary synchronization signal that includes a second repetition of the sequence, the synchronization signal including plurality of initial bits preceding the first repetition of the sequence.

20. The apparatus of claim 19, wherein the synchronization signal further comprises a plurality of tail bits following the second repetition of the sequence.

21. The apparatus of claim 20, wherein the plurality of tail bits is the same as the plurality of initial bits.

22. The apparatus of claim 19, wherein the at least one processor is further configured to:
differentially modulate a base sequence to generate the sequence.

23. The apparatus of claim 19, wherein the synchronization signal further comprises a first secondary synchronization signal and a second secondary synchronization signal, the first secondary synchronization signal and the second secondary synchronization signal to follow both the first primary synchronization signal and the second primary synchronization signal in the synchronization signal.

24. The apparatus of claim 23, wherein each of the secondary synchronization signals comprises a respective Zadoff-Chu sequence.

25. An apparatus for wireless communication, the apparatus comprising:
a memory; and
at least one processor coupled to the memory and configured to:
receive, from a base station, a downlink frame having a first channel time-divisionally multiplexed with at least one other downlink channel;
differentially demodulate a plurality of symbols of the first channel; and
determine whether the first channel is a synchronization channel having at least two repetitions of a sequence based on the differential demodulation of the plurality of symbols.

26. The apparatus of claim 25, wherein the synchronization channel carries a first primary synchronization signal that includes a first repetition of the sequence and a second primary synchronization signal that includes a second repetition of the sequence.

27. The apparatus of claim 25, wherein the at least one processor is further configured to:
detect a first secondary synchronization signal and a second secondary synchronization signal based on at least one repetition of the sequence; and
determine at least one of a frame-level synchronization and a cell identification corresponding to the base station based on both the first and second secondary synchronization signals.

28. The apparatus of claim 25, wherein the at least one processor is further configured to:
sample an N-length sequence of the differentially demodulating symbols of the first channel, wherein N is equal to an expected length of the sequence and a plurality of tail bits.

29. The apparatus of claim 25, wherein the at least one processor is further configured to:
perform at least one of sample-level synchronization and frequency synchronization with the base station based on at least one repetition of the sequence.

30. The apparatus of claim 25, wherein the at least one processor is configured to determine whether the first channel is a synchronization channel having at least two repetitions of a sequence based on the differential demodulation of the symbols based on correlation to determine whether the differentially demodulated symbols indicate a primary synchronization signal (PSS).
